(19) United States
(12) Patent Application Publication
(10) Pub. No.: US 2023/0153388 A1
(43) Pub. Date: May 18, 2023

(54) METHOD FOR CONTROLLING AN AGENT

(71) Applicant: Robert Bosch GmbH, Stuttgart (DE)

(72) Inventors: Davide Barbieri, Eindhoven (NL); Herke Van Hoof, Diemen (NL); Jan Guenter Woehlke, Leonberg (DE)

(21) Appl. No.: 18/054,260

(22) Filed: Nov. 10, 2022

(30) Foreign Application Priority Data
Nov. 17, 2021 (DE) 10 2021 212 906.4

(51) Int. Cl. G06K 9/62; G06F 9/448

(52) U.S. Cl. CPC G06K 9/6263; G06K 9/6256; G06F 9/448

(57) ABSTRACT

A method for controlling an agent. The method includes collecting training data for multiple representations of states of the agent; for every representation and using the training data, training a state encoder, a state decoder, an action encoder and an action decoder, and a transition model, shared for the representations, for latent states, and a Q function model, shared by the representations, for latent states; receiving a state of the agent in one of the representations for which a control action is to be ascertained; mapping the state to one or more latent state(s) using the state encoder for the one of the representations; determining Q values for the state(s) for a set of actions using the Q function model; selecting the control action having the best Q value from the set of actions as the control action; and controlling the agent according to the selected control action.

### CROSS REFERENCE

The present application claims the benefit under 35 U.S.C. § 119 of German Patent Application No. DE 10 2021 212 906.4 filed on Nov. 17, 2021, which is expressly incorporated herein by reference in its entirety.

### FIELD

The present disclosure relates to a method for controlling an agent.

### BACKGROUND INFORMATION

Reinforcement Learning (RL) is a paradigm of machine learning which allows an agent such as a machine to learn to execute a desired behavior with regard to a task specification, e.g., which control measures are to be implemented in order to reach a target destination in a robot navigation scenario. Learning a strategy that generates this behavior with the aid of reinforcement learning differs from learning by supervised learning by the way in which the training data are assembled and maintained. While in supervised learning the supplied training data are made up of mutually adapted pairs of inputs for the strategy (e.g., observations such as measured sensor values) and desired outputs (actions to be executed), there are no fixed training data in reinforcement learning. The strategy is learned from observational data which were collected by the interaction of the agent with its environment, the agent receiving a feedback signal (reward) which evaluates the actions carried out in a certain context (state).

However, reinforcement learning often requires a considerable quantity of such training data in order to converge to a correct solution. Especially when complex tasks are involved, the training therefore necessitates many interactions of the agent with the environment, which could lead to a considerable outlay in an execution in the real word. A training based solely on simulations, which would be less expensive, may lead to poor results, however.

For these reasons, procedures that allow for combined training in different representations of a task are desirable (e.g., simulated and in the real world).

### SUMMARY

According to different embodiments of the present invention, a method is provided for controlling an agent, which includes collecting training data for multiple representations of states of the agent; for every representation and using the training data, training a state encoder for mapping states to latent states in a (shared) latent state room; a state decoder for mapping latent states back from the latent state space; an action encoder for mapping actions to latent actions in a (shared) latent action space and an action decoder for mapping latent actions back from the latent action space, and a transition model, shared for the representations, for latent states and a Q function model, shared for the representations of latent states, using the state encoders, the state decoders, the action encoders and the action decoders. In addition, the method includes receiving a state of the agent in one of the representations for which a control action is to be ascertained; mapping the states to one or more latent state(s) with the aid of the state encoder for the one of the representations; determining Q values for the one or for the multiple latent state(s) for a set of actions with the aid of the Q function model; selecting the control action having the best Q value from the set of actions as a control action; and controlling the agent according to the selected control action.

The above-described method for controlling an agent makes it possible to combine knowledge from different representations of the same task (e.g., the same environment). This accelerates the training in one of the representations by utilizing the knowledge from other representations.

Especially training data obtained in different representations of a task are able to be combined. For instance, training may take place on a less detailed (more abstract), simpler representation of the respective task (which is possible with fewer interactions of the agent with its environment), and the obtained knowledge can then be transferred to a more complex target task actually to be solved by the agent, and the overall training effort be reduced as a result.

The simpler representation may also make it possible to carry out more interactions in a more rapid and/or advantageous manner (in terms of the required resources). For instance, training in the real world may be combined with training in a simulation. Since the training in the real world typically means a high expenditure, for example because it requires human assistance as well as additional hardware, this, too, may reduce the expense of the training.

For example, prior knowledge may exist about a task, e.g., a type of map or a plan or a symbolic representation of the task, which is able to be used (such as in a suitable representation) so that the training process can be accelerated as a whole.

In comparison with the conventional training of a RL control strategy, which must be trained anew for every representation, the data efficiency is able to be increased (that is, the number of required interactions with the environment reduced). In particular interactions in representations that require less work (simulations) may be used and the required number of interactions thus be reduced in representations that require considerable work (interactions with the real world).

In the following text, different exemplary embodiments of the present invention are provided.

Exemplary embodiment 1 is a method for controlling an agent as described above.

Exemplary embodiment 2 is the method according to the exemplary embodiment 1, in which the training is carried out using a loss function which has a loss that provides a reward when it is highly likely that the latent transition model supplies transitions of latent states to which the state encoder (of the respective representation) maps states that have transitioned into one another in the training data.

For example, the latent transition model and the state encoder, the state decoder, the action encoder and the action decoder (or the respective parameters) for all representations are trained using a loss function whose goal it is to maximize the likelihood of the occurrence of the collected interaction data from the representations under the overall model (maximum likelihood method).

The use of such a loss function ensures that the latent transition model is suitable for all representations and is not highly likely to generate transitions that occur only at a low probability in one of the representations.

Exemplary embodiment 3 is the method according to exemplary embodiment 2, in which the loss function has a locality-condition term which penalizes large distances in the state space between (likely) transitions between latent states.

In this way, a meaningful structure of the latent state space is able to be achieved, which is particularly suitable for tasks such as navigation tasks.

Exemplary embodiment 4 is the method according to exemplary embodiment 2 or 3, in which the loss function has a reinforcement-learning loss for the shared Q function model.

During the training, it is therefore possible that all components of the model are trained to reduce the value of the loss function for the training data.

Exemplary embodiment 5 is the method according to exemplary embodiment 4, in which the reinforcement-learning loss is a double deep Q-network loss.

This enables an efficient training of the shared (i.e., latent) Q function model.

Exemplary embodiment 6 is the method according to one of the exemplary embodiments 1 through 5, in which the state encoder and the action encoder map to a respective probability distribution. Instead of a single latent state, the Q function model therefore receives multiple samples (also referred to as particles) of latent states according to the distribution of latent states supplied for the state (from a respective representation) by the respective state encoder.

In other words, the components (e.g., neural networks) carry out a variational inference. This ensures a steady structure of the latent spaces, for instance.

Exemplary embodiment 7 is the method according to one of the exemplary embodiments 1 through 6, in which the representations have a first representation, which is a representation of states in the real world and for which training data are collected through an interaction of the agent with the real world, and the representations have a second representation, which is a representation of states in a simulation and for which training data are collected by a simulated interaction of the agent with a simulated environment.

The combination of training by an interaction in the real world and by an interaction in a simulation makes it possible to considerably reduce the training expense in comparison with an acquisition of training data only in the real world. and it also avoids a quality loss of the training as it happens in a training based purely on a simulation.

However, it is also possible to combine multiple simulations, that is, both (or more) representations may represent simulated states.

Exemplary embodiment 8 is a control device which is designed to carry out a method as recited in one of the exemplary embodiments 1 through 7.

Exemplary embodiment 9 is a computer program which includes instructions that when executed by a processor, induce the processor to carry out a method as recited in one of the exemplary embodiments 1 through 7.

Exemplary embodiment 10 is a computer-readable medium which stores instructions that when executed by a processor, induce the processor to carry out a method as recited in one of the exemplary embodiments 1 through 7.

In the figures, similar reference numerals generally relate to the same parts in all of the different views. The figures are not necessarily true to scale, the general emphasis instead being placed on representing the principles of the present invention. In the following description, different aspects will be described with reference to the figures.

### BRIEF DESCRIPTION OF THE DRAWINGS

FIG. 1 shows a control scenario, according to an example embodiment of the present invention.

FIG. 2 shows a model for learning a control strategy with the aid of reinforcement learning, according to an example embodiment of the present invention.

FIG. 3 illustrates a condition that is implemented by a training loss according to one embodiment of the present invention.

FIG. 4 shows a flow diagram illustrating a method for controlling an agent, according to an example embodiment of the present invention.

### DETAILED DESCRIPTION OF EXAMPLE EMBODIMENTS

The following detailed description relates to the figures, which show as information special details and aspects of this disclosure by which the present invention is able to be implemented. Other aspects may be used, and structural, logical and electrical modifications may be made without departing from the scope of the present invention. The different aspects of this disclosure do not necessarily exclude one another insofar as some aspects of this disclosure are able to be combined with one or more other aspect(s) of this disclosure to generate new aspects.

Different exemplary embodiments will be described in greater detail in the following text.

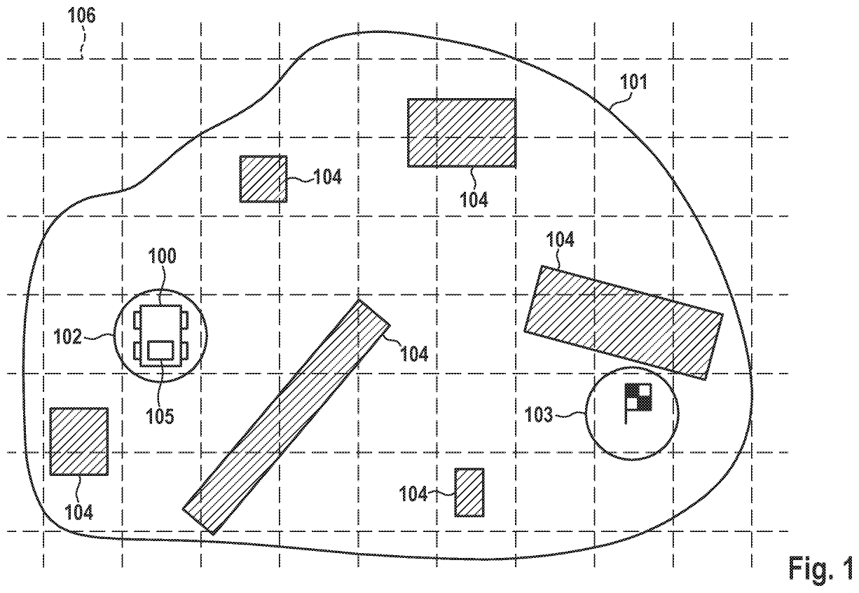

FIG. 1 shows a control scenario.

A controlled object 100 (such as a robot or a vehicle) is located in an environment 101. Controlled object 100 has a start position 102 and is meant to reach a target position 103. Obstacles 104, which the controlled object 100 is to circumvent, are located in environment 101. For example, they must not be passed by controlled object 100 (e.g., walls, trees or rocks) or should be avoided because the agent would damage or injure them (such as pedestrians).

Controlled object 100 is controlled by a control device 105 (control device 105 may be situated in controlled object 100 or possibly also be provided separately thereof, that is, the control object can also be controlled remotely). In the exemplary scenario of FIG. 1, the goal consists of control device 105 controlling controlled object 100 to navigate environment 101 from start position 102 to target position 103. For instance, controlled object 100 is an autonomous vehicle but it can also be a robot provided with legs or chains or some other type of drive system (e.g., a deep-see or Mars rover).

In addition, the embodiments are not restricted to the scenario where a controlled object such as a robot (as a whole) is to be moved between positions 102, 103, but they may also be used for the control of a robot arm, for instance, whose end effectors are to be moved between positions 102, 103 (without encountering obstacles 104), etc.

In the following text, terms like robot, vehicle, machine, etc. are therefore used as examples of the object to be controlled or the computer-controlled system (e.g., a robot with objects in its working area). The described approaches are able to be used with different types of computer-controlled machines such as robots or vehicle and others. Hereinafter, the general term ‘agent’ is especially also used for all types of physical systems that are able to be controlled by the approaches described in the following text. However, the approaches described hereinafter can also be used for all types of agents (e.g., also for an agent which is only simulated and does not physically exist).

In the ideal case, control device 105 has learned a control strategy that enables it to successfully control controlled object 100 (from start position 102 to target position 103, without striking obstacles 104) for a variety of scenarios (i.e., environments, start and target positions) that control device 105 has not encountered so far (during the training).

The control strategy may be learned with the aid of reinforcement learning; and in order to achieve more efficient learning at a low effort, information from different fields is combined such as different types of data (in particular sensor data), e.g., images from the top view, coordinates of controlled object 101, one-hot vectors, . . . , or in other words, different representations of the states of the controlled object and its environment and actions, or to be performed according to the task, possibly with a different degree of detail (e.g., a resolution of images or maps).

In this context, it is not necessary for the combined (or ‘mixed’) information to be available together or at the same time; instead, it can be collected independently in each case. According to different embodiments, a control strategy is trained such that it is able to work in every representation, that is, can suitably control the controlled object in every one of the representations that have occurred during the training, the efficiency of the training becoming more efficient in every representation because knowledge from the training in the other representations it utilized.

The control strategy is represented by a model. It includes neural networks (in particular a neural Q function network) according to the different embodiments. More specifically, it includes components for mapping states and actions from multiple (abstract) representations of the same task (as a Markov decision problem) to the same latent representation with a latent transition model. For every representation, there exists an individual pair of encoder and decoder for states and actions (separately for states and actions) for mapping into and out of the latent representation. Based on ascertained latent states, a neural output network of the model calculates Q values for (discrete) actions, and based on these Q values, actions are selected in the respective representation. The model as a whole is trained by combining a loss term for the latent transition model and the state encoders, state decoders, action encoders and action decoders for all representations, and a classic RL loss term for maximizing the yield from interaction data collected in the different representations (in the same environment).

The model therefore makes it possible to combine information from different representations of the same task (or environment or controlled system) in a latent space.

A locality condition may be used to produce a meaningful structure in the latent representation (in particular for navigation tasks). In the process, (large) spatial distances between temporally consecutive latent states are penalized, the more so the greater the likelihood of such a transition of latent states. As a result, (spatially) local transitions between latent states are forced.

According to different embodiments, the RL control strategy or the Q-network (that is, the neural output network of the model) is trained with the aid of an off-policy double DQN using an experience replay. For example, a separate memory for state transitions is used for this purpose, which stores trajectory sections (for training the transition model). This leads to a high data efficiency during the training of this part of the architecture (Q-network) and may reduce the variance of the gradients during the training of the Q-network.

A high quality of the encodings (as latent values) is achievable through the use of separate encoders and decoders according to different embodiments.

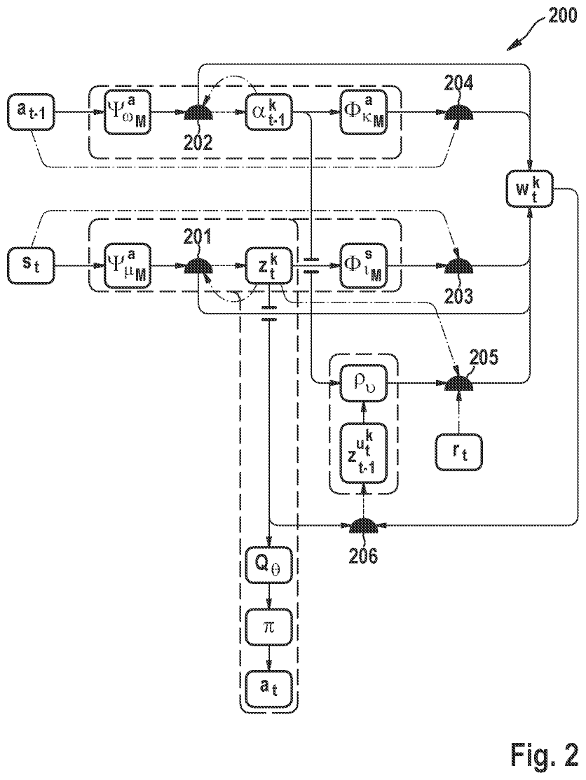

FIG. 2 shows a model 200 for learning a control strategy with the aid of reinforcement learning according to one embodiment. It is implemented by control device 105, for instance.

Model 200 is developed in such a way that it is trained for multiple Markov decision processes (for the same task). In other words, the respective agent learns a state-value function (in the form of a neural Q-network) and thus a control strategy (to the effect that the action having the highest Q value is selected for a state). Additional components are provided for training the Q-network. States and actions are mapped to a latent state space and latent action space. They may be considered a state space and action space of a latent decision process. For the latent states (that is, the states from the latent state space), the Q-network calculates the Q values. During the training, the additional components help in suitably forming the latent decision process (or in other words, in suitably training the latent transition model).

In the training, the inputs for every instant t are the action that the agent has performed at the previous instant (aₜ₋₁) and the resulting state (sₜ) and the resulting reward (rₜ).

The trainable components of the model are the state encoder [symbol] and the state decoder [symbol] the action encoder [symbol] and the action decoder [symbol] the latent transition function (that is, the transition function for the latent decision process) [symbol] and the Q function [symbol] which may likewise be referred to as a “latent” Q function because its input are latent states.

The parameters of the encoders and decoders for states and actions [symbol] and [symbol] depend on the representation for which they are used (that is, in which the action was carried out or the state was achieved, and each representation may be considered a separate Markov decision process). This is meant to indicate that a separate set of encoder and decoder is used for each representation (for states and actions). The encoders and decoders may also have different topologies for different representations.

In the model 200, multiple neural networks perform a variational inference. Their output for an input is therefore a probability distribution, typically by outputting parameters of a probability density function (e.g., a mean value and covariance matrix of a multi-dimensional Gaussian distribution).

Such a network is the state encoder [symbol] for an associated representation, which maps a state in the representation to a probability distribution 201 in the latent state space. According to one embodiment, it outputs probability distribution 201 as a mean value and diagonal covariance matrix of a multidimensional Gaussian distribution. For the sake of simplicity, [symbol] denotes the probability of the latent state z given the state s. For an associated representation, action encoder [symbol] similarly maps an action carried out in the representation to a probability distribution across the latent action space. Latent actions, that is, elements of the latent action space, are differences between two latent states. As a result, latent actions (that is, encodings of actions) have the same dimension as latent states, and the output probability distribution is also a multidimensional Gaussian distribution.

State decoder [symbol] and action decoder [symbol] are trained in such a way that they perform the mappings reversely to the encoders, their outputs also being probability distributions 203, 204.

During the training for evaluating the loss function, a plurality of samples (also referred to as particles) of latent states [symbol] and latent actions [symbol] is taken, where k is the index for the sample, and k=1, . . . , K, that is, K is the number of samples for each time step (with time step index t). This sampling is undertaken to express the uncertainty about the true pair of latent state and latent action. The reparameterization trick may be used to differentiate across the sampling (to ascertain the gradient of the loss function for the training, or in other words, to adapt the parameters of the different neural networks by a backpropagation).

FIG. 2 illustrates the sampling by dotted lines. Dash-dotted lines imply an evaluation of (logarithmized) probabilities. The resulting probability is used to evaluate a weight [symbol] that is, the probability (i.e., likelihood) that a sample (particle) is the true state in the latent state space. It is able to be calculated by

$${w}_{t}^{k} = \frac{{ρ}_{υ} ( {𝓏}_{t}^{k} , {r}_{t} \vert {𝓏}_{t - 1}^{{u}_{t}^{k}} , {α}_{t - 1}^{k} ) {Φ}_{{l}_{ℳ}}^{s} ( {s}_{t} \vert {𝓏}_{t}^{k} ) {Φ}_{{K}_{ℳ}}^{a} ( {a}_{t - 1} \vert {α}_{t - 1}^{k} )}{{Ψ}_{{μ}_{ℳ}}^{s} ( {𝓏}_{t}^{k} , \vert {s}_{t}^{( ℳ )} ) {Ψ}_{{ω}_{ℳ}}^{a} ( {α}_{t - 1}^{k} \vert {a}_{t - 1}^{( m )} )}$$

Here, [symbol] is the index of the precursor [symbol] in the set of samples in the preceding time step [symbol] This is because the preceding latent state [symbol] must be known in order to calculate the (logarithmized) probability of a transition. This preceding state is sampled from the set of samples of the preceding time step at a probability 206, which is directly proportional to the associated weight. [symbol] denotes the latent transition model (like the encoders, decoders and the Q function likewise implemented in the form of a neural network). It is the same for all representations and encodes both the state transitions and the reward function for the latent decision process. Given a latent (preceding) latent [sic] state action and a latent (preceding) action, it supplies a distribution 205 across the latent (next) state and the reward (once again as a parameter of a multidimensional Gaussian distribution).

For the training of the neural networks, the following loss is used

$$ℒ = {λ}_{R L} {ℒ}_{R L} + {λ}_{P F} {ℒ}_{P F}$$

where the two components, the RL loss (double DQN loss) and the particle filter loss, are given by

$${ℒ}_{RL} = - {\sum }_{ℳ} log p ( {Q}^{ℳ ⋆} \vert {Q}_{θ}^{ℳ} )$$

$${ℒ}_{PF} = - {\sum }_{ℳ} {\sum }_{τ} log p ( {𝒟}^{( ℳ , τ )} )$$

The two prefactors [symbol] and [symbol] are weightings. They are suitably selectable with the aid of experiments or can also both be set to equal one.

Thus, one of the objectives consists of minimizing the particle filter loss. It is aimed at maximizing the logarithm of the sum of the weights wₜ^{k}, e.g.,

$$- {ℒ}_{PF}^{ℳ , τ} = {\sum }_{t = 2}^{T} {𝔼}_{{𝓏}_{1 : T}^{1 : K} \sim {Ψ}_{{μ}_{ℳ}}^{s} , {α}_{1 : T}^{1 : K} \sim {Ψ}_{{ω}_{ℳ}}^{a} , {u}_{1 : T}^{1 : K} \sim p ( {u}_{t}^{1 : K} )} [ log ( \frac{1}{K} {\sum }_{K} {w}_{t}^{k} ) ] = {𝔼}_{{𝓏}_{1 : T}^{1 : K} \sim {Ψ}_{{μ}_{ℳ}}^{s} , {α}_{1 : T}^{1 : K} \sim {Ψ}_{{ω}_{ℳ}}^{a} , {u}_{1 : T}^{1 : K} \sim p ( {u}_{t}^{1 : K} )} [ {\sum }_{t = 2}^{T} log ( \frac{1}{K} {\sum }_{K} {w}_{t}^{k} ) ]$$

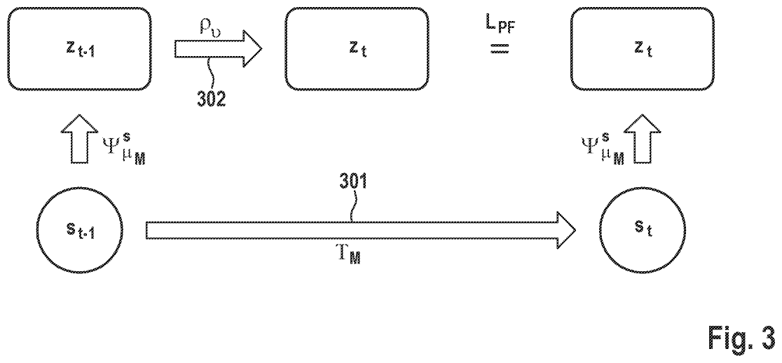

FIG. 3 illustrates the condition imposed by the particle filter loss for the latent transition model: A state transition 301 observed (in the training data) is to correspond to transition 302 of the associated encodings in the latent state space supplied by the transition model.

According to one embodiment, a locality connection is also introduced into the particle loss. It is meant to reduce the distance between two latent states if there is an increasing probability of a direct transition between the two. For this purpose, the particle loss, for example, is given by

$$- {ℒ}_{PF}^{ℳ , τ} = {𝔼}_{{𝓏}_{1 : T}^{1 : K} \sim {Ψ}_{{μ}_{ℳ}}^{s} , {α}_{1 : T}^{1 : K} \sim {Ψ}_{{ω}_{ℳ}}^{a} , {u}_{1 : T}^{1 : K} \sim p ( {u}_{t}^{1 : K} )} [ {\sum }_{t = 2}^{T} log ( \frac{1}{K} {\sum }_{K} {w}_{t}^{k} ) + {λ}_{local} {\sum }_{{k}^{′}} {‖ {𝓏}_{t}^{{k}^{′}} - {𝓏}_{t - 1}^{{u}_{t}^{{k}^{′}}} ‖}_{2}^{2} ]$$

Prefactor λ_{local} is a weighting that may be suitably selected by experiments or also be set to equal one.

The latent Q function [symbol] supplies a state action value (Q value) for every possible action given a set of sampled latent states. The input for the Q-network thus is a concatenation of multiple samples (particles). Entire model 200 may be considered a Q function approximator for multiple decision processes. For a given decision process (that is, a given representation) [symbol] the approximator would be

$${{Q}_{θ} \vert}_{{𝓏}^{k} \sim {Ψ}_{{μ}_{ℳ}}^{s}} ,$$

i.e., the composition of state encoder, sampling (and concatenation) of latent states and the latent Q function. The Q function approximation for [symbol] is denoted by [symbol] According to one embodiment, the latent Q function is trained with the aid of a double DQN (double deep Q-network). It is also used in the inference (that is, in the operation, i.e., in the control following the training) for determining actions for a current state (which is encoded by the state encoder). In the operation, only the latent Q function and the state encoders are used any longer. The encoder is therefore trained both according to the particle filter loss and the double-DQN loss. The other components shown in FIG. 2 (decoders, action encoders and action decoders, transition model) are required only for the training.

Hereinafter, an example is indicated of a training algorithm according to the above procedure. The algorithm is given in pseudo code, and common English key words such as “for”, “end”, “if” and “then” are used.

| | Input: | [symbol] Markov decision processes (MDPs) | | | |
|---|---|---|---|---|---|
| | | m_{b}^{M} replay buffer for transitions in MDP [symbol] | | | |
| | | m_{τ}^{M}, memory for preceding trajectories | | | |
| | | [symbol] model components with parameters | | | |
| | | η, learning rate | | | |
| | | λ_{RL}, λ_{PF}, loss weightings | | | |
| | | λ_{local}, locality condition weighting | | | |
| | | target_q_period, number of steps after the parameters of the | | | |
| | | target Q function are updated | | | |
| | | age_ target, number of steps since the last updating of the | | | |
| | | parameters of the target Q function | | | |
| | Output: | for a batch-trained model | | | |
| 1 | [symbol] _{RL} ← [symbol] _{PP} ← 0 | | | | |
| 2 | for [symbol] in [symbol] do | | | | |
| 3 | \| | if m_{b}^{M} and m_{T}^{M} not empty, then | | | |
| | \| | \| | | | // calculate the RL loss for [symbol] |
| 4 | \| \| | \| \| | $〈 {s}_{t}^{1 : J} , {a}_{t}^{1 : J} , {r}_{t}^{1 : J} , {s}_{t + 1}^{1 : J} 〉 \sim {m}_{b}^{ℳ}$ | | |
| 5 | \| \| | \| \| | $pred ← {Q}_{{θ}_{b}}^{ℳ} ( {s}_{t}^{1 : J} )$ | | |
| 6 | \| \| | \| \| | $approx ← {r}_{t}^{1 : J} + {γ Q}_{{θ}_{b}}^{ℳ} ( {s}_{t}^{1 : J} , arg {max}_{a} {Q}_{{θ}_{b}}^{ℳ} ( {s}_{t}^{1 : J} , a ) )$ | | |
| 7 | \| \| | \| \| | ${ℒ}_{RL} ← {ℒ}_{RL} + {\sum }_{κ} {( pred - approx )}^{2}$ | | |
| | \| | \| | | | // calculate the RL loss for [symbol] |
| 8 | \| \| | \| \| | $〈 {s}_{1 : {n}_{b}}^{1 : J} , {a}_{1 : {n}_{b}}^{1 : J} , {r}_{1 : {n}_{b}}^{1 : J} 〉 \sim {m}_{t}^{ℳ}$ | | |
| 9 | \| | \| | for time step t from 1 to T do | | |
| 10 | \| \| \| | \| \| \| | \| \| \| | ${u}_{t}^{1 : J \times 1 : K} \sim discrete ( \frac{w \text{?}}{\sum \text{?} w \text{?}} )$ | // sample precursor states |
| 11 | \| \| | \| \| | \| \| | ${z}_{t}^{1 : J \times 1 : K} \sim {Ψ}_{μ}^{s} \text{?} ( \cdot \vert {s}_{t}^{1 : J} )$ | // encode current state |
| 12 | \| \| | \| \| | \| \| | ${a}_{t}^{1 : J \times 1 : K} \sim {Ψ}_{{ω}_{ℳ}}^{a} ( \cdot \vert {a}_{t}^{1 : J} )$ | // encode current action |

| | | | | |
|---|---|---|---|---|
| 13 | \| \| | \| \| | \| \| | ${w}_{t}^{k , 1 : J} = log \frac{\text{?}}{\text{?}}$ |
| 14 | \| \| \| | \| \| \| | \| \| \| | ${ℒ}_{PF} ← {ℒ}_{PF} - {\sum }_{f} ( log ( \frac{1}{K} {\sum }_{k} esp {w}_{t}^{jk} ) + {λ}_{local} {\sum }_{{k}^{′}} {‖ {z}_{t}^{{jk}^{′}} - {z}_{t - 1}^{u} \text{?} ‖}_{2}^{2} )$ |

| | | | |
|---|---|---|---|
| 15 | \| | \| | end |

| 16 | \| | end |
|---|---|---|
| 17 | end | |
| 18 | back propagation of [symbol] = λ_{RL} [symbol] _{RL} + λ_{PF} [symbol] _{PF} as to θ_{B}, μ_{M}, ω_{M}, [symbol] , κ_{M} and υ and | |
| | updating of these parameters (via a gradient-based optimization, e.g., Adam | |
| | optimizer) | |
| 19 | if age_target ≥ target_q_period then | |
| 20 | \| | θₜ ← θ_{b} |
| 21 | \| | age_target ← 0 |

| | |
|---|---|
| 22 | end |
| 23 | age_target ← age_target + 1 |

[symbol]

indicates data missing or illegible when filed

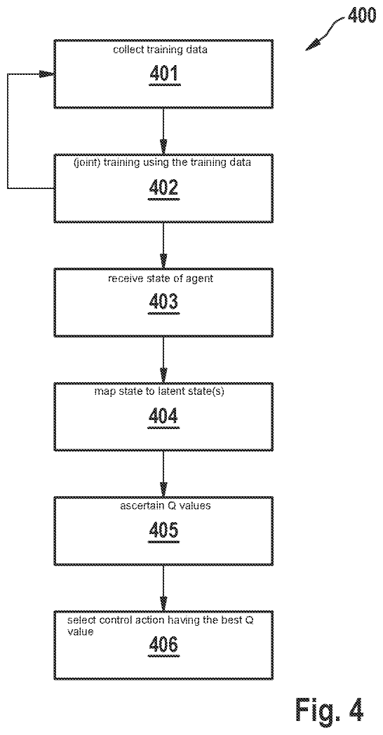

In summary, a method as illustrated in FIG. 4 is provided according to different embodiments.

FIG. 4 shows a flow diagram 400, which illustrates a method for controlling an agent.

In 401, training data are collected for multiple representations of states of the agent.

In 402, using the training data,
(joint) training takes place for every representation, of
   a state encoder for mapping states to latent states in a latent state space,
   a state decoder for mapping latent states back from the latent state space,
   an action encoder for mapping actions to latent actions in a latent action space,
   an action decoder for mapping latent actions back from the latent action space,
a transition model, shared by the representations, for latent states
a Q function model, shared by the representations, for latent states.

The transition model and the Q function model are trained using the state encoders, the state decoders, the action encoders, and the action decoders (for the representations), (parameters of the encoders and decoders being trained as well).

It should be noted that the collecting of training data in 401 and the training in 402 is carried out in alternation, that is, the training data are collected using the current state encoder and the Q function model in the one or more representation(s) and are written into corresponding memories, and the (entire) model is trained on that basis. In other words, the collecting of the data in 401 and the training of the model are repeated in alternation until the training of the model (i.e., the mentioned model components) is concluded.

In 403, (e.g., following the concluded training), a state of the agent for which a control action is to be ascertained is received in one of the representations.

In 404, the state is mapped to one or more latent state(s) (e.g., to samples from a distribution of latent states) with the aid of the state encoder for the one of the representations. For instance, the state is first mapped to a distribution of latent states, from which latent states are then sampled. This may be seen as mapping the state to the sampled latent states.

In 405, Q values for the one or the plurality of latent state(s) (e.g., the samples, also referred to as particles) are ascertained for a set of actions with the aid of the Q function model.

In 406, the control action having the best Q value is selected as a control action from the set of actions and the agent is controlled according to the selected control action.

According to different embodiments, multiple representations in a latent model (having a latent state space, a latent action space, a latent transition function, and a latent Q function model) are thus merged, so to speak.

The method of FIG. 4 is able to be carried out by one or more computer(s) using one or more data processing unit(s). The term “data processing unit” may be understood as some type of entity that allows for the processing of data or signals. For example, the data or signals may be handled according to at least one (that is, one or more than one) special function, which is carried out by the data processing unit. A data processing unit may include an analog circuit, a digital circuit, a logic circuit, a microprocessor, a microcontroller, a central unit (CPU), a graphics processing unit (GPU), a digital signal processor (DSP), an integrated circuit of a programmable gate array (FPGA), or some other combination thereof, or it may be made up of such. Some other way of implementing the respective functions that are described in greater detail herein may also be understood as a data processing unit or a logic circuit system. One or more of the method step(s) individually described herein is/are able to be carried out (e.g., implemented) by a data processing unit using one or more special function(s) carried out by the data processing unit.

The approach from FIG. 4 can be used to generate a control signal for some physical system (having a mechanical part whose movement is controlled) such as a robot device, which might be a computer-controlled machine, a vehicle, a household appliance, an electric tool, a production machine, a personal assistant, or an access control system. A control rule for the physical system is learned, and the physical system then controlled accordingly.

One example is a self-driving car for which a control device is to be trained or a control strategy to be learned. The car may collect training data in a real test environment, e.g., by recording camera images, or training data are able to be collected in a simulation of the test environment, in which x-y coordinates and distances from obstacles instead of images are collected in the simulation as information about control states (i.e., observations) because this information can easily be determined in a simulation. The approach from FIG. 4 now makes it possible to train a control strategy (e.g., in the form of a neural Q-network) in order to operate the vehicle; and the same action space is assumed for both representations (the real world with image data as state information (observations) and the simulation with coordinates and distance as state information) in that separately trained encoders for both representations map the states (observations) to a shared latent space. A transition model is learned for the latent space for which the knowledge obtained in both representations is used. On the basis of the latent space, an output section (which includes the Q-network) calculates actions and control signals independently of the representation in which the vehicle is currently operated (under the assumption of identical action spaces).

Different embodiments may receive sensor signals from different sensors such as video, radar, LiDAR, ultrasound, movement, heat imaging, etc. and utilize the sensor signals, for instance in order to acquire sensor data with regard to states of the controlled system (e.g., robots and an object or objects). Embodiments are able to be used for training a machine learning system and controlling a robot, e.g., autonomously of robot manipulators, to carry out different manipulation tasks in different scenarios. In particular, embodiments are able to be used to control and monitor the execution of manipulation tasks such as on assembly lines.

Although special embodiments have been illustrated and described here, one skilled in the art will recognize that the depicted and described special embodiments may be exchanged for a multitude of alternative and/or equivalent implementations without deviating from the protective scope of the present invention. This application is meant to cover different adaptations or variations of the example embodiments described herein.

What is claimed is:

1. A method for controlling an agent, comprising the following steps:
collecting training data for multiple representations of states of the agent;
training, using the training data:
for each representation of the representations, a state encoder for mapping states to latent states in a latent state space, a state decoder for mapping latent states back from the latent state space, an action encoder for mapping actions to latent actions in a latent action space, and an action decoder for mapping latent actions back from the latent action space; and
a transition model, shared for the representations, for latent states, and a Q function model, shared for the representations, for latent states using the state encoder, the state decoder, the action encoder and the action decoder,
receiving a state of the agent in one of the representations for which a control action is to be ascertained;
mapping the state to one or more latent states with using the state encoder for the one of the representations;
determining Q values for the one or more of latent states for a set of actions using the Q function model;
selecting a control action having the best Q value from the set of actions as the control action; and
controlling the agent according to the selected control action.

2. The method as recited in claim 1, wherein the training is carried out using a loss function which has a loss that provides a reward when it is highly likely that the latent transition model supplies transitions between latent states to which the state encoder maps states that have transitioned into one another in the training data.

3. The method as recited in claim 2, wherein the loss function has a locality condition term which penalizes large distances in the latent state space between probable transitions between latent states.

4. The method as recited in claim 2, wherein the loss function has a reinforcement-learning loss for the shared Q function model.

5. The method as recited in claim 4, wherein the reinforcement learning loss is a double deep Q-network loss.

6. The method as recited in claim 1, wherein the state encoder and the action encoder map to a respective probability distribution.

7. The method as recited in claim 1, wherein the representations have a first representation, which is a representation of states in a real world and for which training data are collected through an interaction of the agent with the real world, and the representations have a second representation, which is a representation of states in a simulation and for which training data are collected through a simulated interaction of the agent with a simulated environment.

8. A control device configured to control an agent, the control device configured to:
collect training data for multiple representations of states of the agent;
train, using the training data:
for each representation of the representations, a state encoder for mapping states to latent states in a latent state space, a state decoder for mapping latent states back from the latent state space, an action encoder for mapping actions to latent actions in a latent action space, and an action decoder for mapping latent actions back from the latent action space; and
a transition model, shared for the representations, for latent states, and a Q function model, shared for the representations, for latent states using the state encoder, the state decoder, the action encoder and the action decoder,
receive a state of the agent in one of the representations for which a control action is to be ascertained;
map the state to one or more latent states with using the state encoder for the one of the representations;
determine Q values for the one or more of latent states for a set of actions using the Q function model;
select a control action having the best Q value from the set of actions as the control action; and
controlling the agent according to the selected control action.

9. A non-transitory computer-readable medium on which are stored instructions for controlling an agent, the instructions, when executed by a computer, causing the computer to perform the following steps:
collecting training data for multiple representations of states of the agent;
training, using the training data:
for each representation of the representations, a state encoder for mapping states to latent states in a latent state space, a state decoder for mapping latent states back from the latent state space, an action encoder for mapping actions to latent actions in a latent action space, and an action decoder for mapping latent actions back from the latent action space; and
a transition model, shared for the representations, for latent states, and a Q function model, shared for the representations, for latent states using the state encoder, the state decoder, the action encoder and the action decoder,
receiving a state of the agent in one of the representations for which a control action is to be ascertained;
mapping the state to one or more latent states with using the state encoder for the one of the representations;
determining Q values for the one or more of latent states for a set of actions using the Q function model;
selecting a control action having the best Q value from the set of actions as the control action; and
controlling the agent according to the selected control action.
